(19) United States
(12) Patent Application Publication
(10) Pub. No.: US 2005/0066308 A1
(43) Pub. Date: Mar. 24, 2005

(54) Application program verification system and method using separate debugging information files

(76) Inventor: Min-ja Han, Seoul (KR)

Correspondence Address: HARNESS, DICKEY & PIERCE, P.L.C., P.O. BOX 8910, RESTON, VA, 20195, US

(21) Appl. No.: 10/943,003

(22) Filed: Sep. 17, 2004

(30) Foreign Application Priority Data
Sep. 18, 2003 (KR) 03-64723

(51) Int. Cl. G06F 9/44

(52) U.S. Cl. 717/124

(57) ABSTRACT

A computer program, system and method for micro controller unit (MCU) application program verification may provide source code program level debugging using different versions of debugging information files. The MCU application program verification may simultaneously debug information created by different versions of development tools, assign a highest priority to a debugging information file corresponding to a most recently updated source code program, and construct a corresponding debugging information data structure. Previously debugged source code programs and recently updated source code programs may be simultaneously debugged without changing images corresponding to the already debugged source code programs.

### CROSS REFERENCE TO RELATED APPLICATION

This application claims the priority of Korean Patent Application No. 2003-64723, filed on Sep. 18, 2003, in the Korean Intellectual Property Office, the disclosure of which is hereby incorporated by reference in its entirety.

### BACKGROUND OF THE INVENTION

1. Field of the Invention

[0002]The present invention relates to a micro controller unit (MCU) application program verification system which provides for source code level debugging when using different versions of debugging information files.

2. Description of the Related Art

In MCU development, there may be different assembly language levels, which may contribute to an increase in the probability of MCU application programs containing bugs. Debugged MCU application programs may be downloaded to a memory, i.e., a target, in image file formats as read only memory (ROM) codes. Once the MCU application programs have been downloaded to the target, the rewrite images may not be altered. Therefore, when developing an MCU application program, the corresponding image files should undergo various debugging tests. However, debugging tests may create overhead for the development of MCU application programs.

During the development of MCU application programs using, for example, “C” programming language source code programs, the tools that may be used for MCU development may require updating. The tools, for example, compilers, assemblers, or linkers may require a more recent update. Additionally, after MCU application programs have been developed and used in previous projects the programs may need to be re-used for a newer project, thus the MCU development tools may be updated since the last development project. For example, image files may be changed by updated versions of compilers or optimizers. If linkers have been updated since the last MCU development, then file rearrangement may also be required.

Users may not desire to rebuild previous programs with updated application programs, and perform redundant debugging processes on previously debugged application programs using updated development tools.

Source code level debugging may include converting developed MCU application programs into image files before downloading the application programs to a target. The debugging process may require various software programs, executing image files, matching the executed values with source code programs, and verifying the results which may be desired by a user. Source code level debugging may be performed by downloading image files to a target located on an MCU board, and comparing the executed values of the image files with source code programs. A debugging engine, which uses one of the MCU development tools, i.e., a debugger, may be divided into two roles. The first role may be to map lines of a source code program to respective addresses and the second role may be to map variables to data values.

While an MCU application program project is being developed, the MCU application program may include a plurality of source code programs. An MCU application programmer may produce many source code programs in the development of an application program project. As shown in FIG. 1, each of source code programs A.c and B.c may be compiled and assembled, thus creating object programs. The object programs created may, for example, be combined into one image file AB.hex, for downloading to a target location, and one debugging information file AB.dbg, for input to a debugger through a linking process. The compiling, assembling, and linking processes may be controlled by a user interface (UI).

The debugger, which may be controlled by the UI, may receive the debugging information file AB.dbg, create debugging information, and display the created debugging information for a user. The user may perform a verification process at a source code level using the debugging information. The debugging information may include file information, function information, line information, and/or symbol information, as illustrated in FIG. 2. The debugging information may include mapped products of addresses or data values.

A conventional debugger may construct a debugging information data structure as shown in FIG. 2, for use in source code level debugging. The process of constructing a debugging information data structure may include parsing a debugging information file (AB.dbg) which may be produced from source code programs (A.c and B.c). The object programs produced from the source code programs (A.c and B.c) may be merged into a specified location of an address map through linking, and may be further produced into one image file (AB.hex). In conventional debugging, since all or a portion of the source code program (A.c) that has already been debugged may be included in the newly updated source code program (B.c), a rebuilding process may be required to produce a merged form, for example, one image file (AB.hex) and one debugging information file (AB.dbg).

A conventional debugger may statically construct a debugging information data structure from only one debugging information file. The user may have to perform a rebuilding process by merging all previous source code programs for reuse by a new project, including source code programs that have already undergone tests and verification. The user may desire to reuse the debugged source code programs without modification or rebuilding of the debugged source code programs and perform debugging at a previous source code level, when reusing the debugged source code programs. Updating development tools for conventional debugging may require a rebuilding process including merging previously debugged source code programs into new source code programs. The results of the rebuilding process may include changes in the size, location, and the image of the debugged source code programs. Previously debugged source code programs may become obsolete over time, thus requiring updated debugging on the previously debugged source code programs.

### SUMMARY OF THE INVENTION

Exemplary embodiments of the present invention provide an MCU application program verification method, system, and computer program by which debugging information files created by different versions of development tools may be simultaneously processed by a debugger. A highest priority may be assigned to debugging information files which correspond to more recently updated source code programs, and a corresponding debugging information data structure may be constructed in the form of a plurality of arrays. Therefore debugging already debugged source code programs and recently updated source code programs, at a source code level, may be accomplished without changing images corresponding to already debugged source code programs.

An exemplary embodiment of the present invention provides a micro controller unit (MCU) application program verification method, system, apparatus, or computer program which may be implemented by a debugger, to include receiving at least two debugging information files corresponding to at least two source code programs, assigning priority to each of the debugging information files received, searching for debugging information in a debugging information file having a highest priority, and searching for the debugging information in the debugging information file having a lower priority, if the debugging information is not found in the debugging information file having the highest priority.

Exemplary embodiments of the present invention may include an apparatus which contains an input/output device, a central processing unit, and a database. The database may include a user interface, and application program, an image engine and a debugger.

Another exemplary embodiment of the present invention may provide a method for developing first and second source code programs, where the second source code program contains a substantial portion of the first source code program, and performing first compiling, assembling and linking operations on the first source code program to generate at least one of an image file, a debugging information file and/or a script file based on the first linking operation. The method may further include performing second compiling, assembling and linking operations on the second source code program, generating at least another one of an image file, a debugging information file, and a script file based on the second linking operation. The method may also provide writing an absolute label address which corresponds to the substantial portion of the first source code program contained in the second source code program by referring to the at least one file generated from the first linking operation.

Another exemplary embodiment of the present invention may provide a method for debugging a first source code program while searching a second source code program for debugging information. The debugging information may correspond to an address label, and the searching operation may include performing a jump to an absolute address of the label. The method may further provide writing an image file which corresponds to the first source code program to an image file unit, after it has been debugged, debugging the image file corresponding to the debugged first source code program, and transmitting the debugged image file to a target location. Transmitting the debugged image file to a target location may include overwriting a previous image file with the debugged image file.

### BRIEF DESCRIPTION OF THE DRAWINGS

The present invention will become more apparent to those of ordinary skill in the art by describing, in detail, exemplary embodiments thereof with reference to the attached drawings in which:

FIG. 1 illustrates a conventional procedure of creating an image file;

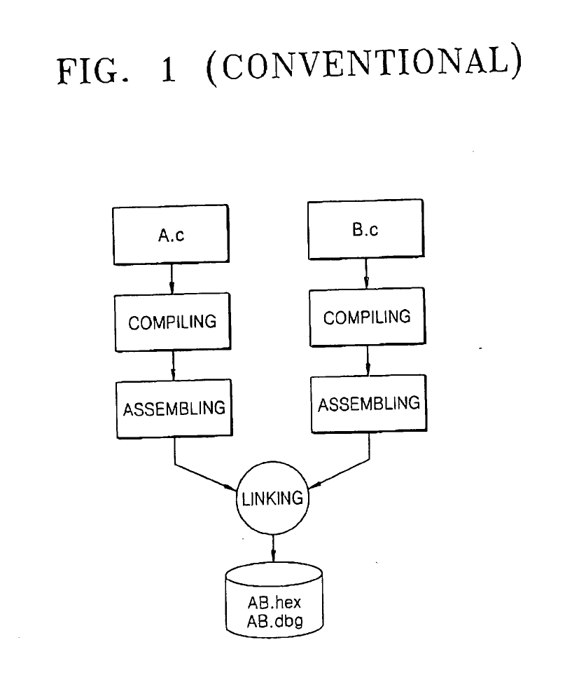

FIG. 2 illustrates a conventional debugging information data structure;

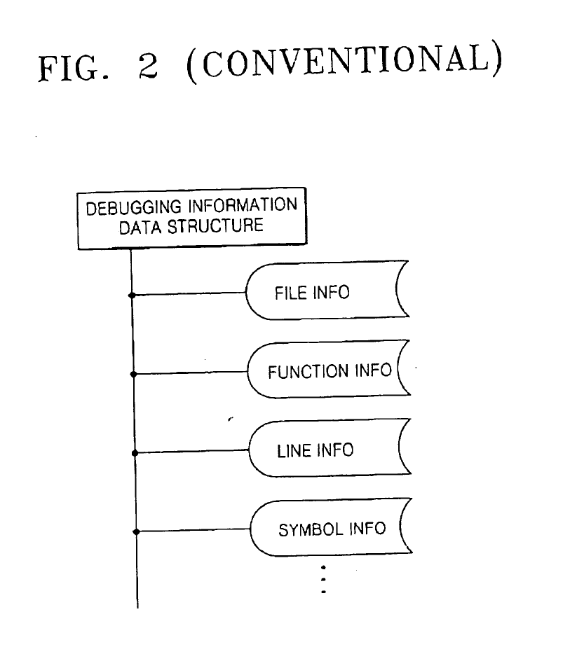

FIG. 3 is a block diagram of an MCU application program verification system according to an exemplary embodiment of the present invention;

FIG. 4 is a exemplary block diagram of the image engine illustrated in FIG. 3;

FIG. 5 is an exemplary block diagram for creating an image file in the MCU application program verification system of FIG. 3;

FIG. 6 illustrates image file formats stored in separate application programs according to an exemplary embodiment of the present invention;

FIG. 7 is a flowchart illustrating an exemplary operation of searching for debugging information of the debugger of FIG. 3;

FIG. 8 illustrates a debugging information data structure according to an exemplary embodiment of the present invention;

FIG. 9 illustrates formats of image files downloaded to a target, according to an exemplary embodiment of the present invention; and

FIG. 10 is a flowchart illustrating an exemplary operation of assigning priority of the debugger of FIG. 3.

### DETAILED DESCRIPTION OF EXEMPLARY EMBODIMENTS OF THE INVENTION

Hereinafter, exemplary embodiments of the present invention will be described in detail with reference to the accompanying drawings. In general, the exemplary embodiments may be directed to an apparatus, method and computer program for receiving debugging information files and searching for debugging information.

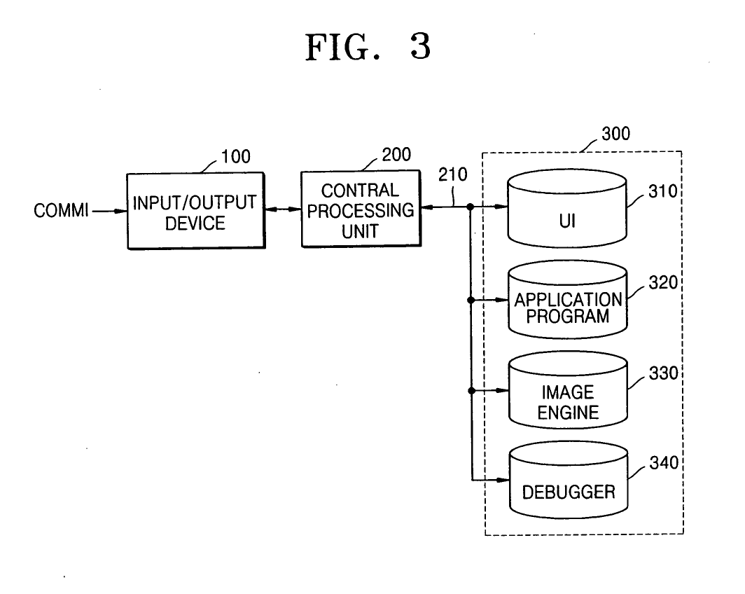

FIG. 3 is a block diagram of an MCU application program verification system according to an exemplary embodiment of the present invention. Referring to FIG. 3, the MCU application program verification system may include an input/output device 100, a central processing unit (CPU) 200, and a database 300.

The input/output device 100 may receive and process a debugging command (COMMI) input by a user through a corresponding user interface (UI). The input/output device 100 may output debugging command information to the CPU 200, for source code programs to be debugged, and display output debugging information. The output debugging information corresponds to the debugging command information. The user may perform a debugging process while viewing the debugging information on a monitor included in the input/output device 100, which displays the debugging information.

The CPU 200 may read UI specific data and display the UI to the user through the input/output device 100. Using a debugger, the CPU 200 may receive debugging information files corresponding to source code programs to be debugged. The CPU 200 may also receive a plurality of related source code programs and dynamically assign priority to each of the debugging information files. The CPU 200 may perform preferential searches for debugging information based on a highest priority, and output debugging information in a debugging information file with the highest priority. If the specified debugging information is not found in the debugging information file with the highest priority, the debugging information may be searched for in a debugging information file having a lower priority. The debugging information files may include files produced by different versions of development tools, i.e., compilers, assemblers, and linkers, for example, and when the debugging information files are produced by different versions of development tools, they may still be reused without a rebuilding process.

The database 300 illustrated in FIG. 3 may include a UI unit 310, an application program unit 320, an image engine unit 330, and a debugger unit 340, according to an exemplary embodiment of the present invention. The UI unit 310 may store user interface programs, the application program unit 320 may store source code programs, and the debugger unit 340 may store the debugger. The image engine unit 330 may store debugging information files, produced by the CPU 200, by compiling, assembling, and linking the source code programs.

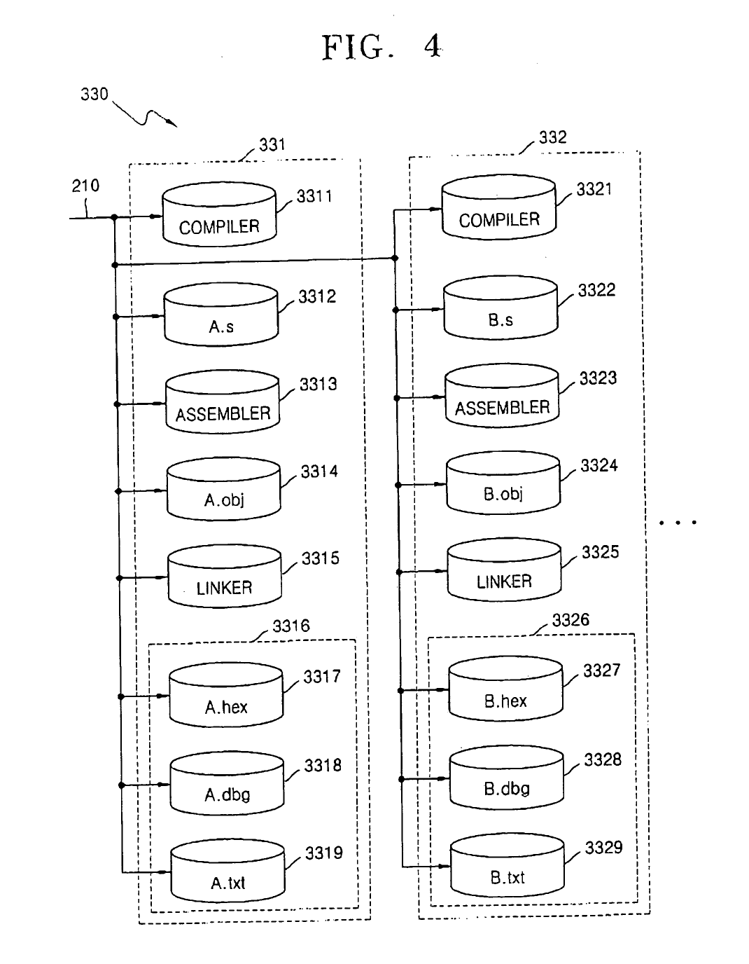

FIG. 4 is a detailed block diagram of the image engine unit 330 of FIG. 3, according to an exemplary embodiment of the present invention. Referring to FIG. 4, the image engine unit 330 may include a plurality of separate engine units 331 and 332, for example. The engine units 331 and 332 may include compiler units 3311 and 3321, assembly program units 3312 and 3322, assembler units 3313 and 3323, object program units 3314 and 3324, linker units 3315 and 3325, and debugging information file units 3316 and 3326. In FIG. 4, the databases for storing programs are shown in pairs, however, development tools of different versions or different databases which store different programs may be further included in the image engine.

The compiler units 3311 and 3321 may store compilers used by the CPU 200 to compile the source code programs. The compilers may be different versions from one another, however, all the compilers may be the same and contain the same compiler versions.

The assembly program units 3312 and 3322 may store assembly programs A.s and B.s produced from compiling. The assembler units 3313 and 3323 may store assemblers used to assemble the assembly programs (A.s and B.s). The assemblers may be different versions from one another, however, all the assemblers may be the same and contain the same version.

The object program units 3314 and 3324 may store object programs A.obj and B.obj produced from assembly. The linker units 3315 and 3325 may store linkers used for the CPU 200 to link the object programs (A.obj and B.obj). The linkers may be different versions from one another, however, all the linkers may be the same and contain the same version.

The debugging information file units 3316 and 3326 may store debugging information files (A.dbg and B.dbg) produced by the CPU 200 by linking the object programs (A.obj and B.obj). The debugging information file unit 3316, for example, may further include an image file unit 3317 and a script file unit 3319, and the debugging information file unit 3326 may further include an image file unit 3327 and a script file unit 3329. The image file units 3317 and 3327 may store image files (A.hex and B.hex) produced by the CPU 200 by linking the object programs (A.obj and B.obj). The image files (A.hex and B.hex) may vary between binary and text forms. The script file units 3319 and 3329 may store script files (A.txt and B.txt) produced by the CPU 200, by linking the object programs (A.obj and B.obj). The image engine 330, having been described as containing two separate engines 331 and 332, is not limited in scope to any specified number of engine units. The number of engine units within the image engine 330 may be represented by an integer N>1, according to an exemplary embodiment of the present invention.

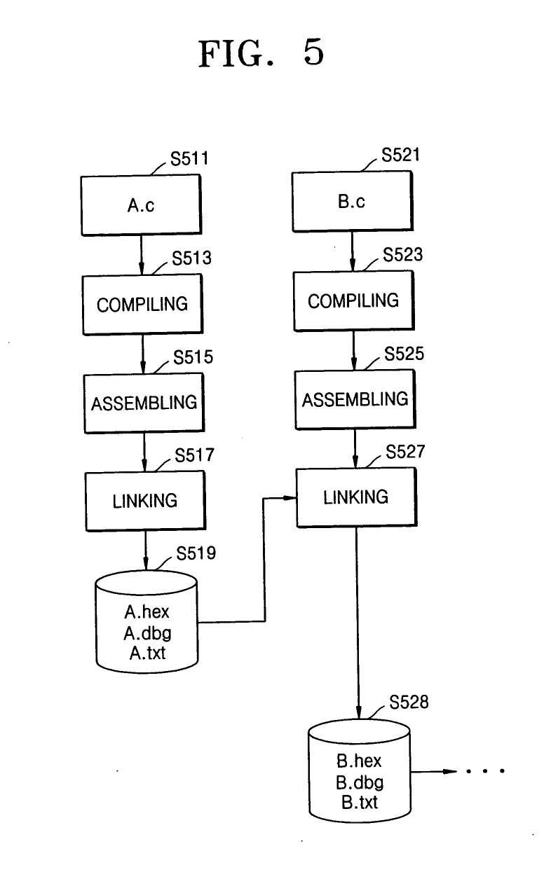

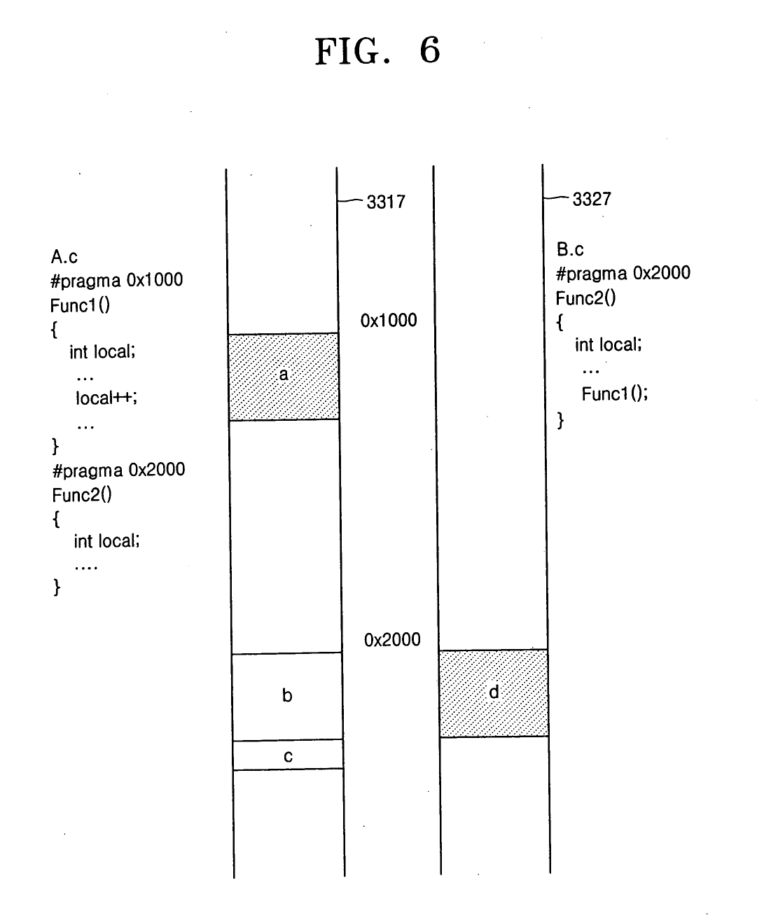

FIG. 5 illustrates a procedure for creating an image file in the MCU application program verification system of FIG. 3, according to an exemplary embodiment of the present invention. As illustrated in FIG. 5, a procedure of converting a plurality of source code programs A.c and B.c for example, into corresponding image files A.hex and B.hex, debugging information files A.dbg and B.dbg, and script files A.txt and B.txt, may be accomplished with different versions of development tools, i.e., compilers, assemblers, and linkers. For example, in S511, a first source code program A.c may be developed by a user as an MCU application program. Debugging the first source code program A.c, in S513 through S517, the user executes the UI via the input/output device 100 and may perform compiling, assembling, and linking on the first source code program A.c through the UI. As a result of linking the first source code program A.c, the image file A.hex, the debugging information file A.dbg, and the script file A.txt may be obtained, as illustrated in S519. The user may input debugging command (COMMI) through the UI, and once the debugger is executed, the debugging may be performed. The debugger may compute codes that are previously requested by the user in the first source code program A.c, for debugging. The codes computed by the debugger may include file information, function information, line information, and symbol information at a break point. The debugging information computed by the debugger may be displayed to the user via the input/output device 100. Assuming that an error is corrected through debugging the first source code program A.c, and debugging is completed, the image file A.hex corresponding to the debugged first source code program A.c, may be written to the image file unit 3317 of FIG. 4, as illustrated in the exemplary embodiment of FIG. 6. The image file A.hex stored in the image file unit 3317 may be downloaded to a target location, for example, read only memory (ROM), random access memory (RAM), flash random access memory (FRAM), or any other memory for driving an MCU after completion of a debugging process.

In S521, the user may develop a new source code program B.c. The second source code program B.c may be based on the first source code program A.c, which for exemplary purposes, may be an MCU application program developed in a first project. It may be assumed that the second source code program B.c has all or a portion of the first source code program A.c as a subroutine contained therein. To debug the second source code program B.c, the user may execute the UI via the input/output device 100 and perform compiling, assembling, and linking on the second source code program B.c through the UI, as illustrated in S523 to S527 of FIG. 5. The compilers, assemblers, and linkers used on the more recently updated source code program B.c, may be different from those used on a previously updated source code program A.c. The image file creation procedure illustrated in FIG. 5, having been described with two separate source code programs A.c and B.c, is not limited in scope to any specified number of source code programs. The number of source code programs which may be implemented into an image file creation procedure may be represented by an integer N>1, according to an exemplary embodiment of the present invention.

As a result of linking the second source code program B.c, the image file B.hex, the debugging information file B.dbg, and the script file B.txt may be obtained in S528. The linking operation may provide for writing an absolute address of a label corresponding to a subroutine, when the image file B.hex is formed, by referring to the script file A.txt of the first source code program A.c. The user may provide the input debugging command (COMMI) through the UI to execute the debugger, thus performing debugging.

The debugger may compute codes that have been previously requested by a user in the second source code program B.c for debugging purpose, i.e., debugging information, which may include file information, function information, line information, and symbol information. The debugger may compute the previously requested codes and may also compute variable information, using the debugging information files A.dbg and B.dbg. The debugging information computed by the debugger may be displayed to the user through the input/output device 100.

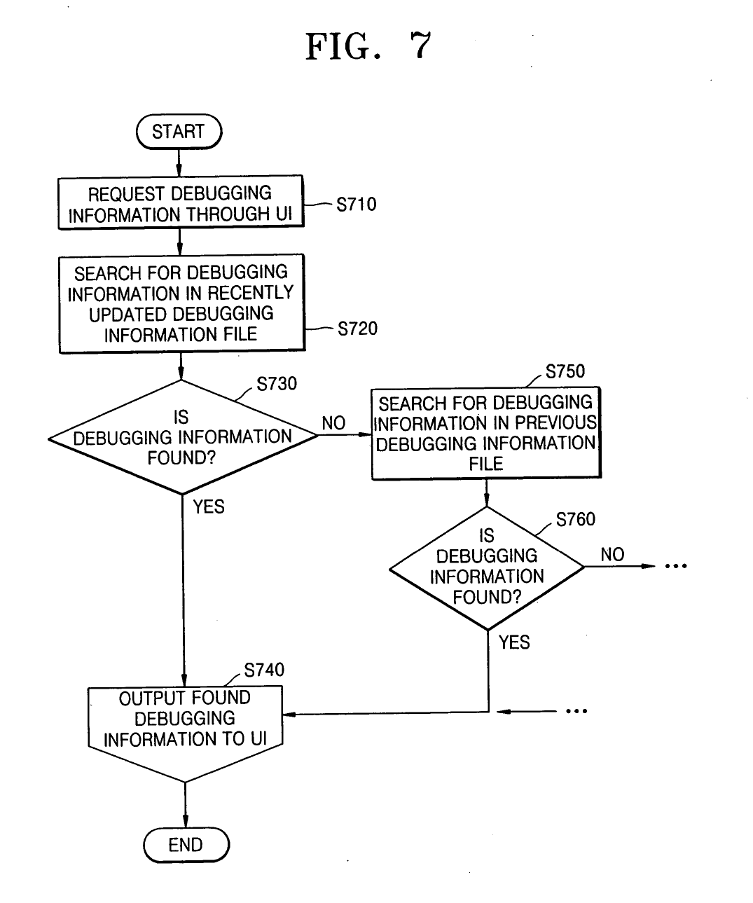

The operation of the debugger 330, illustrated in an exemplary embodiment of FIG. 3, is illustrated in greater detail in FIG. 4, and in the flowchart of FIG. 7, according to an exemplary embodiment of the present invention. FIG. 7 is a flowchart illustrating an exemplary operation of the debugger of FIG. 3. Referring to FIG. 7, once the user requests the debugging information, by inputting the debugging command (COMMI) through the U1 illustrated in S710, the CPU 200 may then execute the debugger. The debugger may receive the debugging information files A.dbg and B.dbg, which correspond to the second source code program B.c to be debugged and the first source code A.c previously debugged, and dynamically assigns priority to each of the debugging information files having a single data structure. The single data structure may be in the form of a plurality of arrays or a list.

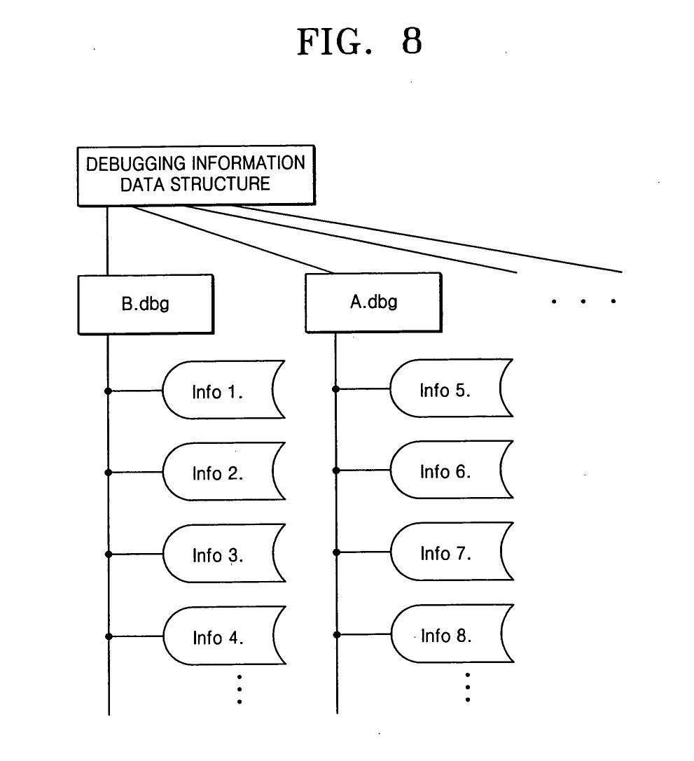

If the first source code program A.c uses all or a portion of another source code program (e.g., B.c) as a subroutine, the CPU 200 may further receive another debugging information file (e.g., B.dbg) which may be created by linking the source code program B.c. Assigning a priority to each of the debugging information files of A.dbg and B.dbg, is illustrated in an exemplary embodiment of FIG. 8. In an exemplary embodiment of the present invention, a highest priority may be assigned to a recently updated debugging information file B.dbg, for example, and the lower priority may be assigned to a previously modified debugging information file A.dbg, for example. Assignment may be performed, for example, when the recently updated debugging information file B.dbg is first set up in a header and the debugging information file A.dbg, which contains the lower priority, may be set up when the debugger creates a debugging information list. Therefore, the CPU 200 may be configured to perform preferential searches for debugging information in the recently updated debugging information file B.dbg, for example, and output the obtained debugging information to the UI, as illustrated in S720 through S740 of FIG. 7.

If the debugging information which may be requested by a user is not found in the debugging information file having a higher priority B.dbg, for example, the debugging information may then be searched for in a previously debugged information file A.dbg containing a lower priority, as illustrated in S750 through S760 of FIG. 7. The priority searching procedure illustrated in FIG. 7, having been described with two priority levels which correspond to debugging information files A.dbg and B.dbg, is not limited in scope to a specified number of debugging information files which may be assigned a priority level. The number of debugging information files which may be assigned a priority may be represented by an integer N>1, according to an exemplary embodiment of the present invention.

According to another exemplary embodiment of the present invention, if the CPU 200 searches for debugging information unsuccessfully in both the higher priority debugging information file and in the lower priority debugging information file, then a jump operation may be performed. During the linking operation, and in accordance with a corresponding option added during the linking operation, a jump may be made to the absolute address of a corresponding label of the script file A.txt. The jump may allow debugging information to be searched for in the corresponding label. For example, as illustrated in an exemplary embodiment of FIG. 6, while debugging is performed on the second source code program B.c, debugging information corresponding to a label (Func1) may be searched for in the debugging file A.dbg, corresponding to the previously debugged first source code program A.c, through a jump to an absolute address of a label “0X1000” contained in the image file A.hex of 3317.

The exemplary embodiments of the present invention may provide processes for debugging information files created by different versions of development tools using the same debugger, dynamically assigning the highest priority to the debugging information file B.dbg corresponding to the recently developed source code program, and constructing a debugging information data structure in the form of a plurality of arrays, as illustrated in FIG. 8. Therefore, in accordance with an exemplary embodiment of the present invention, it may be possible to debug a source code program which has been previously debugged, A.c for example, and a recently updated new source code program, B.c for example, without having to change the image file corresponding to the previously debugged source code program A.c.

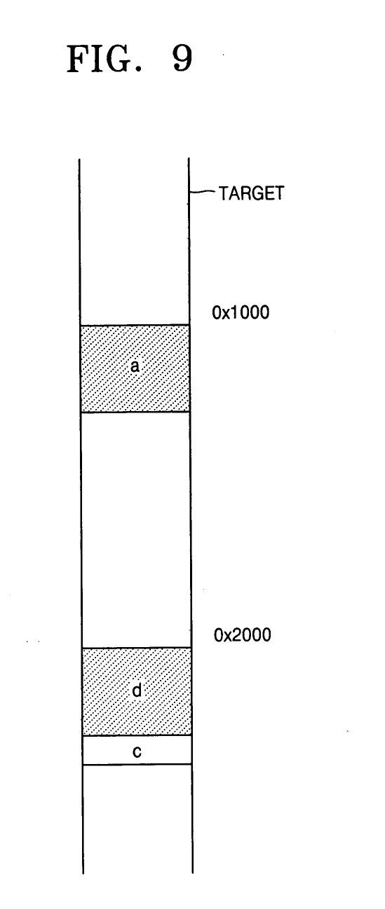

Once an error is corrected by debugging the second source code program B.c, the image file B.hex corresponding to the second source code program B.c may be written to the image file unit 3327, as illustrated in an exemplary embodiment of FIG. 6. The image file B.hex stored in the image file unit 3327 may be debugged and downloaded to a target location. If each of the source code programs A.c and B.c, for example, are debugged and the final image files A.hex and B.hex are completed, the image file corresponding to the first source code program A.c may be downloaded to the target location followed by final image files A.hex and B.hex. The image file B.hex, corresponding to the updated second source code program B.c, may then overwrite the previously written image file located at the target. Once the image files A.hex and B.hex, which correspond to the source code programs A.c and B.c, as illustrated in FIG. 6, are downloaded to the target, their formats may be implemented according to the illustration of FIG. 9. Referring to FIG. 9, the target location is illustrated as containing components (a) and (d) of the first and second source code programs A.c and B.c.

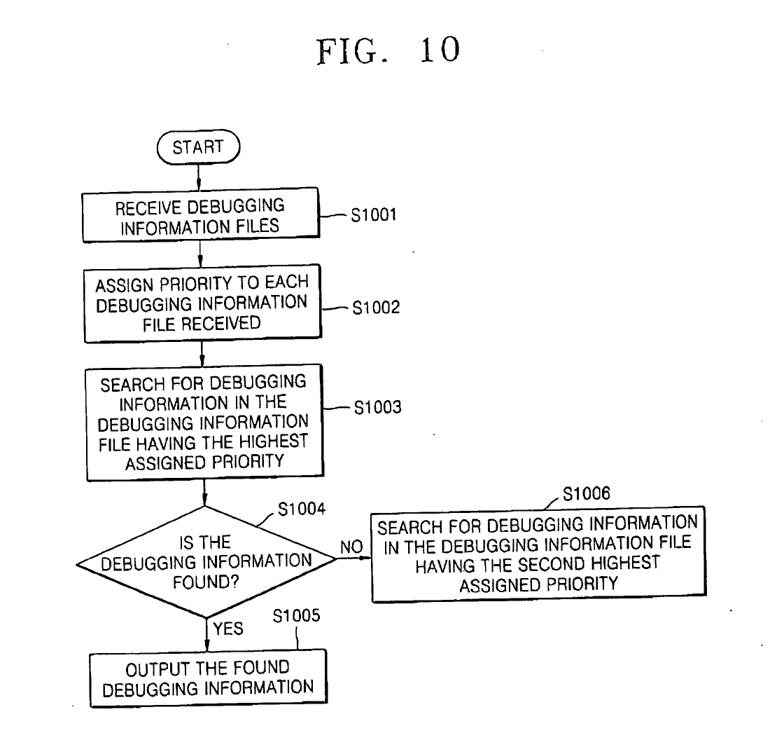

FIG. 10, according to an exemplary embodiment of the present invention, illustrates a method of assigning priority to the debugging information files, and searching for debugging information in a debugging information file having a higher priority, as illustrated in S1001-S1003. If the debugging information is not found in the debugging information file having the higher priority (S1006), then during S1004 a search for the debugging information may be performed on a debugging information file having a lower priority, for example a next highest priority, until the debugging information is found (S1005).

The MCU application program verification system, according to an exemplary embodiment of the present invention, may simultaneously debug the debugging information created by different versions of development tools, dynamically assign a highest priority to the debugging information file corresponding to the most recently updated source code program, and/or create a debugging information data structure in the form of a plurality of arrays. Therefore, it may be possible to debug source code programs which may have been previously debugged, and more recently updated source code programs at the same time, without changing image files corresponding to the previously debugged source code programs.

The exemplary method of FIG. 10 may be embodied in software as a computer program. For example, a program in accordance with the exemplary embodiments of the present invention may be a computer program product causing a computer to execute the exemplary method of application program verification.

The computer program product may include a computer-readable medium having computer program logic or code portions embodied thereon for enabling a processor, for example, to perform the methodology of searching for debugging information in accordance with the exemplary method.

The computer-readable storage medium may be a built-in medium installed inside a computer main body or removable medium arranged so that it can be separated from the computer main body.

Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory such as memory cards; and media with a built-in ROM, such as ROM cassettes.

The computer program logic may thus cause the processor to perform one or more of S1001-S1006. Therefore, by causing a computer to execute the program, the assignment and searching of debugging information may be performed by the method. As a result, the searching functions provided by the computer executing the program may be similar to the searching functions provided by the exemplary program verification method.

These programs may also be provided in the form of an externally supplied propagated signal and/or a computer data signal embodied in a carrier wave. The computer data signal embodying one or more instructions or functions of the exemplary methodology may be carried on a carrier wave for transmission and/or reception by an entity that executes the instructions or functions of the exemplary methodology. For example, the functions or instructions of the exemplary embodiments may be implemented by processing one or more code segments of the carrier wave in a computer controlling a processor for executing the assignment and searching functions, in accordance with the exemplary program verification method described herein.

Further, such programs, when recorded on computer-readable storage media, may be readily stored and distributed. The storage medium, as it is read by a computer, may thus enable the verification method described herein.

The exemplary embodiments of the present invention being thus described, it will be obvious that the same may be varied in many ways. For example, the functional blocks in FIGS. 3-5 describing the exemplary methods may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations or functions. The computer executable program(s) may also be provided as part of externally supplied propagated signal(s). Such variations are not to be regarded as departure from the spirit and scope of the exemplary embodiments of the present invention, and all such modifications as would be obvious to one skilled in the art are intended to be included within the scope of the following claims.

1. A micro controller unit (MCU) application program verification method comprising:
receiving at least two debugging information files corresponding to at least two source code programs;
assigning priority to each of the debugging information files received;
searching for debugging information in a debugging information file having a highest priority; and
searching for the debugging information in a debugging information file having a lower priority, if the debugging information is not found in the debugging information file having the highest priority.

2. The MCU application program verification method of claim 1, wherein at least one debugging information file can be reused without performing a rebuilding operation, wherein the at least one debugging information file has been created by at least one development tool that is a different version from at least one another development tool used to create a more recent debugging information file, said at least one debugging information file and said more recent debugging information file corresponding to at least two source code programs, where at least one of the at least two source code programs is developed based on another of the at least two source code programs.

3. A micro controller unit (MCU) application program verification method comprising:
receiving and processing debugging commands;
outputting debugging command information for source code programs to be debugged and displaying related debugging information corresponding to the debugging command information;
receiving debugging information files corresponding to the source code programs;
assigning priority to each of the debugging information files received;
searching for debugging information in a debugging information file having a highest priority; and
searching for the debugging information in a debugging information file having a lower priority if the debugging information is not found in the debugging information file having the highest priority.

4. The MCU application program verification method of claim 3, wherein searching for the debugging information in the debugging information file having the lower priority includes jumping to an absolute address of a script file.

5. The MCU application program verification method of claim 3, wherein at least one debugging information file can be reused without performing a rebuilding operation, wherein the at least one debugging information file has been created by at least one development tool that is a different version from at least one another development tool used to create a more recent debugging information file, said at least one debugging information file and said more recent debugging information file corresponding to at least two source code programs, where at least one of the at least two source code programs is developed based on another of the at least two source code programs.

6. The MCU application program verification method of claim 5, wherein said at least one development tool and said at least one another development tool are compilers.

7. The MCU application program verification method of claim 5, wherein said at least one development tool and said at least one another development tool are assemblers.

8. The MCU application program verification method of claim 5, wherein said at least one development tool and said at least one another development tool are linkers.

9. A micro controller unit (MCU) application program verification system comprising:
a debugger which receives debugging information files corresponding to at least two source code programs;
assigns priority to each of the debugging information files received, and searches for debugging information in a debugging information file having a highest priority; and
searches for the debugging information in a debugging information file having a lower priority if the debugging information is not found in the debugging information file having the highest priority.

10. The MCU application program verification system of claim 9, wherein at least one debugging information file can be reused without performing a rebuilding operation, wherein the at least one debugging information file has been created by at least one development tool that is a different version from at least one another development tool used to create a more recent debugging information file, said at least one debugging information file and said more recent debugging information file corresponding to at least two source code programs, where at least one of the at least two source code programs is developed based on another of the at least two source code programs.

11. A micro controller unit (MCU) application program verification system comprising:
an input/output device, which receives and processes debugging commands input by a user through a user interface, outputs debugging command information for source code programs to be debugged, and displays debugging information output corresponding to the debugging command information;
a central processing unit, which reads a debugger in response to the debugging command information, receives debugging information files corresponding to the source code programs, assigns a priority to each of the debugging information files, searches for debugging information in a debugging information file having a highest priority, and searches for the debugging information in a debugging information file having a lower priority if the debugging information is not found in the debugging information file having the highest priority; and
a database, which provides the user interface, the source code programs, the debugging information files, and the debugger.

12. The MCU application program verification system of claim 11, wherein when the debugging information is searched for in the debugging information file having the lower priority, the central processing unit searches for the debugging information file by jumping to an absolute address of a corresponding label of a script file created when object programs are linked.

13. The MCU application program verification system of claim 11, wherein the debugging information files can be reused without performing a rebuilding operation, wherein the at least one debugging information file has been created by at least one development tool that is a different version from at least one another development tool used to create a more recent debugging information file, said at least one debugging information file and said more recent debugging information file corresponding to first and second source code programs, wherein one of the first and second source code programs is developed based on the another of the first and second source code programs.

14. The MCU application program verification system of claim 13, wherein said at least one development tool and said at least one another development tool are compilers.

15. The MCU application program verification system of claim 13, wherein said at least one development tool and said at least one another development tool are assemblers.

16. The MCU application program verification system of claim 13, wherein the development tools include linkers.

17. The MCU application program verification system of claim 11, wherein the database comprises:
a user interface unit, which stores the user interface programs;
an application program unit, which stores the source code programs;
an image engine unit, which stores debugging information files created by the central processing unit by compiling, assembling, and linking the source code programs; and
a debugger unit, which stores the debugger.

18. The MCU application program verification system of claim 17, wherein the image engine unit comprises:
at least two compiler units, which store compilers used for the central processing unit to compile the source code programs;
at least two assembly program units, which store assembly programs created by the compiling;
at least two assembler units, which store assemblers used by the central processing unit to assemble the assembly programs;
at least two object program units, which stores object programs created by the assembling;
at least two linker units, which store linkers used for the central processing unit to link the object programs; and
at least two debugging information file units, which store debugging information files created by the central processing unit by linking the object programs.

19. The MCU application program verification system of claim 18, wherein the image engine unit contains at least two image file units which store image files created by the central processing unit by linking the object programs.

20. The MCU application program verification system of claim 18, wherein the image engine unit comprises at least two script file units which store script files created by the central processing unit by linking the object programs.

21. A method of creating image files for a MCU application program comprising:
developing first and second source code programs, said second source code program containing a substantial portion of the first source code program;
performing first compiling, assembling and linking operations on the first source code program; and
performing second compiling, assembling and linking operations on the second source code program, wherein at least one development tool used for at least one of said second operations is different from at least one another development tool used for at least one another of said first operations.

22. A method of creating image files for a MCU application program comprising:
developing first and second source code programs said second source code program containing a substantial portion of the first source code program;
performing first compiling, assembling and linking operations on the first source code program and generating at least one of an image file a debugging information file and a script file based on the first linking operation;
performing second compiling, assembling and linking operations on the second source code program, and generating at least another one of an image file a debugging information file and a script file based on the second linking operation; and
writing an absolute address of a label corresponding to the substantial portion of the first source code program contained in the second source code program by referring to the generated at least one file, based on the first linking operation.

23. A method of debugging source code programs for a MCU application program comprising:
debugging a first source code program;
searching a second source code program for debugging information which corresponds to a label, during the debugging of the first source code program, said searching includes performing a jump to an absolute address of the label;
writing an image file which corresponds to the debugged first source code program to an image file unit;
debugging the image file corresponding to the debugged first source code program and transmitting the debugged image file to a target location; and
overwriting a previous image file corresponding to the second source code program with the debugged image file of the first source code program at the target location.

24. A method for locating debugging information comprising:
requesting debugging information;
searching for debugging information in a recently updated debugging information file; and
searching for the debugging information in a less recently updated debugging information file, if the debugging information is not found in the recently updated debugging information file.

25. A computer program product comprising a computer-readable medium having computer program logic stored thereon for enabling a processor to perform application program verification, the computer program logic causing the processor to perform the functions of:
receiving at least two debugging information files corresponding to at least two source code programs;
assigning priority to each of the debugging information files received;
searching for debugging information in a debugging information file having a highest priority; and
searching for the debugging information in a debugging information file having a lower priority, if the debugging information is not found in the debugging information file having the highest priority.

26. A computer data signal embodied in a carrier wave, the computer data signal comprising:
a first code segment for receiving at least two debugging information files corresponding to at least two source code programs;
a second code segment for assigning priority to each of the debugging information files received;
a third code segment for searching for debugging information in a debugging information file having a highest priority; and
a fourth code segment for searching for the debugging information in a debugging information file having a lower priority, if the debugging information is not found in the debugging information file having the highest priority.
